(19) United States
(12) Patent Application Publication
(10) Pub. No.: US 2022/0201143 A1
(43) Pub. Date: Jun. 23, 2022

(54) INFORMATION PROCESSING DEVICE AND NON-TRANSITORY COMPUTER READABLE MEDIUM

(71) Applicant: FUJIFILM Business Innovation Corp., Tokyo (JP)

(72) Inventor: Takayuki MATSUI, Kanagawa (JP)

(73) Assignee: FUJIFILM Business Innovation Corp., Tokyo (JP)

(21) Appl. No.: 17/341,251

(22) Filed: Jun. 7, 2021

(30) Foreign Application Priority Data
Dec. 22, 2020 (JP) 2020-212718

(51) Int. Cl. H04N 1/00; G06K 9/00

(52) U.S. Cl. CPC H04N 1/00782; G06K 9/00449; H04N 1/00785; H04N 1/00331

(57) ABSTRACT

An information processing device includes a processor configured to: receive a setting of a scanning definition, the scanning definition being a definition to be used when scanning information in a first document in which information has been written or inputted into predetermined fields; and cause a result obtained by using the scanning definition to scan a document of similar type to the first document, namely a second document in which information has been written or inputted into predetermined fields, to be displayed.

### CROSS-REFERENCE TO RELATED APPLICATIONS

This application is based on and claims priority under 35 USC 119 from Japanese Patent Application No. 2020-212718 filed Dec. 22, 2020.

### BACKGROUND

### (i) Technical Field

The present disclosure relates to an information processing device and a non-transitory computer readable medium.

### (ii) Related Art

Japanese Unexamined Patent Application Publication No. 10-334182 discloses a technology by which scan position information to be used in scanning by an optical character reading device is created more efficiently.

### SUMMARY

A form scanning definition, which contains preset scanning ranges at which to scan information written or inputted into a form in advance, is created on the basis of a single form in many cases. Also, it is anticipated that a scanning definition created on the basis of a first form will be applied to another form of similar type to the first form to scan information that has been written or inputted into the other form in advance. In this case, differences in the information written or inputted into each of the first form and the other form in advance may result in situations where the scanning ranges in the scanning definition are too narrow to read the relevant information, or conversely, the scanning ranges may be too wide and unwanted information may be read. Consequently, it is preferable to check the validity of the application of the scanning definition.

Aspects of non-limiting embodiments of the present disclosure relate to checking the validity of whether or not a scanning definition, that is, a definition used when scanning a document in which information has been written or inputted into predetermined fields, is applicable to another document of similar type.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing device includes a processor configured to: receive a setting of a scanning definition, the scanning definition being a definition to be used when scanning information in a first document in which information has been written or inputted into predetermined fields; and cause a result obtained by using the scanning definition to scan a document of similar type to the first document, namely a second document in which information has been written or inputted into predetermined fields, to be displayed.

### BRIEF DESCRIPTION OF THE DRAWINGS

Exemplary embodiments of the present disclosure will be described in detail based on the following figures, wherein:

FIG. 1 is a diagram illustrating a schematic configuration of a form system;

FIG. 2 is a block diagram illustrating a hardware configuration of an information processing device;

FIG. 3 is a flowchart illustrating the flow of a display process by the information processing device;

FIG. 4 is a first display example displayed on a screen of a client terminal;

FIG. 5 is a second display example displayed on the screen of the client terminal;

FIG. 6 is a third display example displayed on the screen of the client terminal;

FIG. 7 is a fourth display example displayed on the screen of the client terminal;

FIG. 8 is a fifth display example displayed on the screen of the client terminal;

FIG. 9 is a sixth display example displayed on the screen of the client terminal;

FIG. 10 is a seventh display example displayed on the screen of the client terminal;

FIG. 11 is an eighth display example displayed on the screen of the client terminal;

FIG. 12 is a ninth display example displayed on the screen of the client terminal;

FIG. 13 is a 10th display example displayed on the screen of the client terminal;

FIG. 14 is an 11th display example displayed on the screen of the client terminal;

FIG. 15 is a 12th display example displayed on the screen of the client terminal;

FIG. 16 is a 13th display example displayed on the screen of the client terminal;

FIG. 17 is a 14th display example displayed on the screen of the client terminal;

FIG. 18 is a 15th display example displayed on the screen of the client terminal;

FIG. 19 is a 16th display example displayed on the screen of the client terminal; and

FIG. 20 is a 17th display example displayed on the screen of the client terminal.

### DETAILED DESCRIPTION

### First Exemplary Embodiment

Hereinafter, a form system 10 according to an exemplary embodiment will be described.

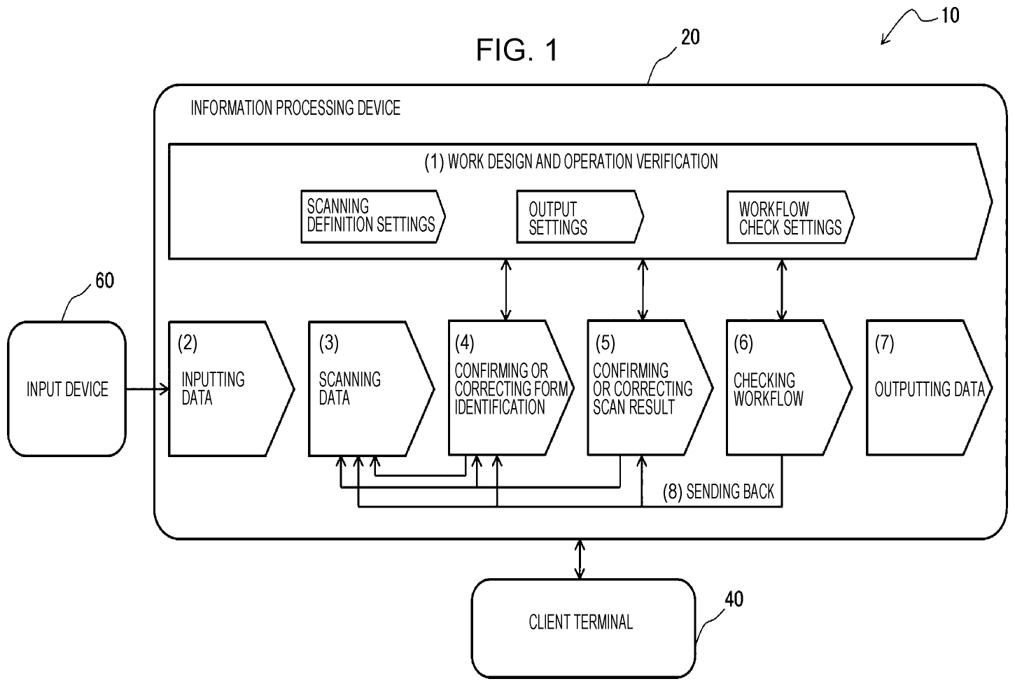

FIG. 1 is a diagram illustrating a schematic configuration of the form system 10 according to the exemplary embodiment.

As illustrated in FIG. 1, the form system 10 includes an information processing device 20, a client terminal 40, and an input device 60. These devices are connected to a network not illustrated, and are capable of communicating with each other over the network. The Internet, a local area network (LAN), or a wide area network (WAN) is applied as the above network, for example.

The information processing device 20 manages the flow of a series of process that includes performing an optical character recognition (OCR) process on the image data of a multi-page document containing a form, the image data being inputted through the input device 60, and outputting the result of the OCR process to a predetermined destination. A specific configuration and action of the information processing device 20 will be described later.

The client terminal 40 transmits various instructions related to the OCR process to the information processing device 20. For example, the various instructions include an instruction for starting a scan of information in the image data and an instruction for displaying a result of scanning information in the image data. Also, the client terminal 40 displays various information, such as the result of the OCR process performed by the information processing device 20 according to various received instructions, and notifications related to the OCR process. For the client terminal 40, a server computer or a general-purpose computer device such as a personal computer (PC) is applied, for example. In FIG. 1, only a single client terminal 40 is illustrated, but the configuration is not limited thereto. Multiple client terminals 40 may also be prepared, and different client terminals 40 may be used for different processes, for example.

The input device 60 inputs image data to be subjected to the OCR process into the information processing device 20. For the input device 60, a server computer, a general-purpose computer device such as a PC, or an image forming device including functions such as a scanner function, a printer function, and a fax machine function is applied, for example. Note that image data may also be inputtable into the information processing device 20 from the client terminal 40 in addition to the input device 60.

Next, an overview of the form system 10 will be described. The form system 10 is a system in which the information processing device 20 performs the OCR process on image data inputted through the input device 60, and outputs the result of the OCR process to a predetermined destination.

In the OCR process, the information processing device 20 manages the various processes of (1) workflow design and operation verification, (2) inputting data, (3) scanning data, (4) confirming or correcting the form identification, (5) confirming or correcting the scan result, (6) checking the workflow, (7) outputting data, and (8) sending back. In the exemplary embodiment, the OCR process is used to refer to not only the process of simply reading information such as characters and symbols from image data, but also post-processing such as character correction.

As an example of managing the various processes, the processes of (1) workflow design and operation verification, (2) inputting data, (3) scanning data, (6) checking the workflow, and (7) outputting data are each executed by the information processing device 20 automatically. Also, as an example of managing the various processes, the processes of (4) confirming or correcting the form identification and (5) confirming or correcting the scan result are each received by input from the user through the client terminal 40. Also, as an example of managing the various processes, the process of (8) sending back may be executed by the information processing device 20 automatically in some cases, and may also be received by input from the user through the client terminal 40 in some cases.

In the process of (1) workflow design and operation verification, job rules including scanning definition settings, output settings, and workflow check settings are created. In the scanning definition settings, scanning ranges prescribing ranges from which to read information in the image data in the process of “(3) scanning data” are set, for example. As a more specific example, a definition may be set so as to read a field value existing as a nearby value to the right of a field extracted as a key. In the output settings, the file format and destination of the output data to be output in the process of “(7) outputting data” are set, for example. In the workflow check settings, format settings such as required input fields and the number of inputtable characters in the form to be detected in the process of “(6) checking the workflow” are set, for example.

In the process of (2) inputting data, image data is received from the input device 60 as input. The image data received as input is registered as a job, which is the unit of execution in the process of “(3) scanning data”.

In the process of (3) scanning data, job rules for the job to be executed which are selected by the user from among job rules created in the process of “(1) workflow design and operation verification” are used to read information in the image data of the job. For example, in this process, a process of identifying the form included in the image data in the job (hereinafter referred to as “form identification”) and a process of reading characters and symbols inside the scanning ranges are performed.

In the process of (4) confirming or correcting the form identification, the image data in the job is divided into records indicating the form included in the job, on the basis of the result of the form identification performed in the process of “(3) scanning data”. Thereafter, in this process, the divided records are displayed, and a confirmation or correction of the form identification is received from the user.

In the process of (5) confirming or correcting the scan result, the result of scanning characters and symbols inside the scanning ranges performed in the process of “(3) scanning data” is displayed, and a confirmation or correction of the scan result is received from the user.

In the process of (6) checking the workflow, errors in each of the preceding processes are detected according to the workflow check settings included in the job rules for the job that were selected by the user from among the job rules created in the process of “(1) workflow design and operation verification”. The detection result may also be presented to the user.

In the process of (7) outputting data, output data is created using the output settings included in the job rules for the job that were selected by the user from among the job rules created in the process of “(1) workflow design and operation verification”, and the created output data is output to a predetermined destination.

In the process of (8) sending back, a process executed in the OCR process is sent back one or multiple stages. As an example, an instruction for sending back is given by the user from the client terminal 40 during the execution of the various processes such as “(4) confirming or correcting the form identification” and “(5) confirming or correcting the scan result”. As another example, an instruction for sending back is given from the client terminal 40 of an administrator according to the result of a check by the administrator performed between the processes of “(6) checking the workflow” and “(7) outputting data”.

In the above OCR process, the process of “(1) workflow design and operation verification” is executed before the processes from “(3) scanning data” onward are performed, or in other words, before the form system 10 is put into operation. Furthermore, the process of “(1) workflow design and operation verification” may also be executed during the operation of the form system 10 in which the processes from “(3) scanning data” onward are being performed. As an example, the job rules created in the process of “(1) workflow design and operation verification” before the form system 10 is put into operation may be corrected appropriately according to the result of the process of “(5) confirming or correcting the scan result” while the form system 10 is in operation.

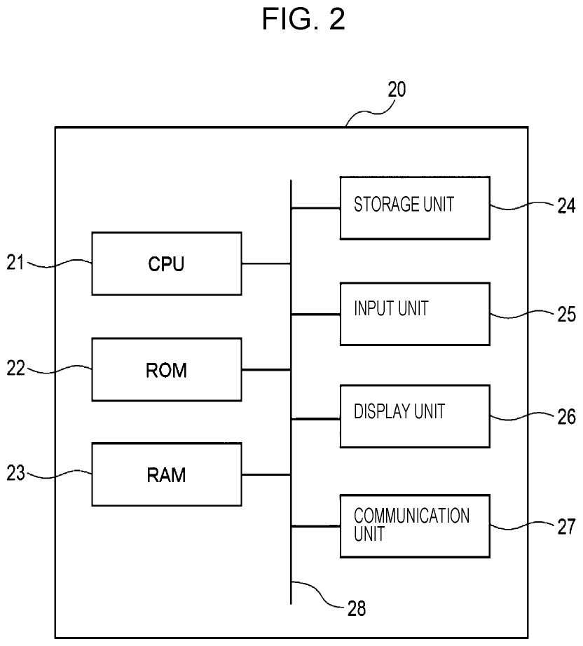

FIG. 2 is a block diagram illustrating a hardware configuration of the information processing device 20. For the information processing device 20, a server computer or a general-purpose computer device such as a PC is applied, for example.

As illustrated in FIG. 2, the information processing device 20 is provided with a central processing unit (CPU) 21, read-only memory (ROM) 22, random access memory (RAM) 23, a storage unit 24, an input unit 25, a display unit 26, and a communication unit 27. These components are communicably interconnected through a bus 28. The CPU 21 is one example of a “processor”.

The CPU 21 is a central processing unit that executes various programs and controls each unit. In other words, the CPU 21 reads out a program from the ROM 22 or the storage unit 24, and executes the program while using the RAM 23 as a work area. The CPU 21 controls each unit described above and performs various arithmetic processing in accordance with the program stored in the ROM 22 or the storage unit 24. In the exemplary embodiment, an information processing program for executing at least a display process described later is stored in the ROM 22 or the storage unit 24. Note that the information processing program may be preinstalled in the information processing device 20, or the information processing program may be stored in a non-volatile storage medium or distributed over a network and installed in the information processing device 20 appropriately. Anticipated examples of the non-volatile storage medium include a CD-ROM, a magneto-optical disc, a hard disk drive (HDD), a DVD-ROM, flash memory, or a memory card.

The ROM 22 stores various programs and various data. The RAM 23 temporarily stores programs or data as a work area.

The storage unit 24 includes a storage device such as an HDD, a solid-state drive (SSD), or flash memory, and stores various programs, including an operating system, and various data.

The input unit 25 includes a pointing device such as a mouse and a keyboard, and is used to input various information.

The display unit 26 is a liquid crystal display, for example, and displays various information. The display unit 26 may also adopt touch panel technology and function as the input unit 25.

The communication unit 27 is an interface for communicating with other equipment such as the client terminal 40. The communication is achieved by using a wired communication standard such as Ethernet® or FDDI, or a wireless communication standard such as 4G, 5G, or Wi-Fi®, for example.

When executing the information processing program described above, the information processing device 20 uses the hardware resources described above to execute a process based on the information processing program.

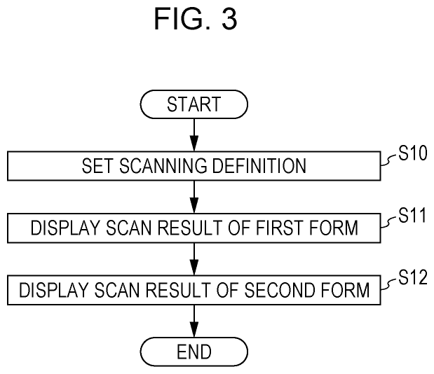

FIG. 3 is a flowchart illustrating the flow of a display process by the information processing device 20 that causes a scan result to be displayed, the scan result being obtained by using a scanning definition to scan image data of a multi-page document containing a form in which information has been written or inputted into predetermined fields. The display process is performed by having the CPU 21 read out the information processing program from the ROM 22 or the storage unit 24, load the information processing program into the RAM 23, and execute the information processing program. The form is one example of a “document”.

In step S10 illustrated in FIG. 3, the CPU 21 receives the setting of a scanning definition, which is a definition to be used when scanning information in a first form in which information has been written or inputted into predetermined fields from among the multi-page document described above. Subsequently, the flow proceeds to step S11. In the first exemplary embodiment, the initial or leading form from among multiple pages of forms included in a single job is treated as the “first form” as an example. The first form is one example of a “first document”.

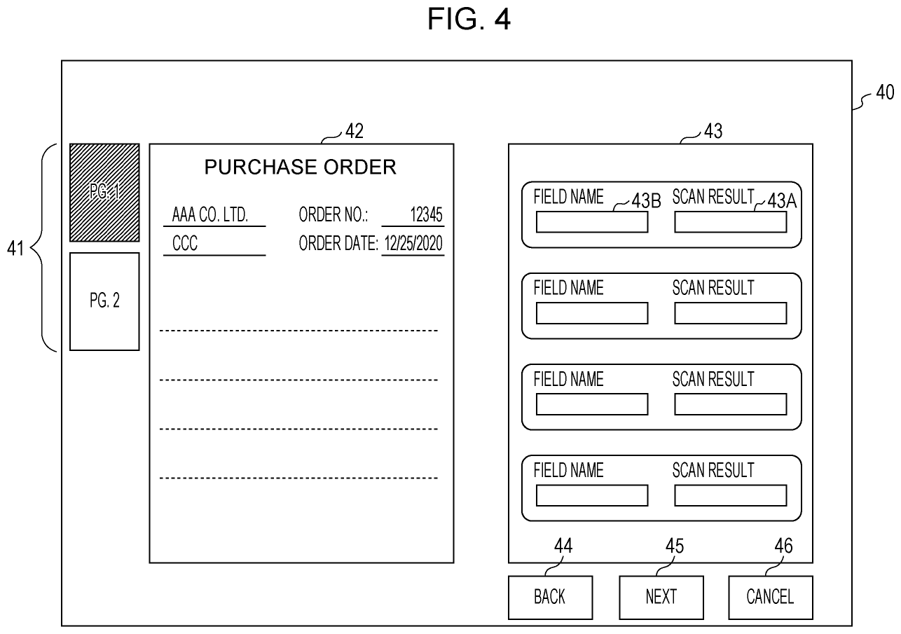

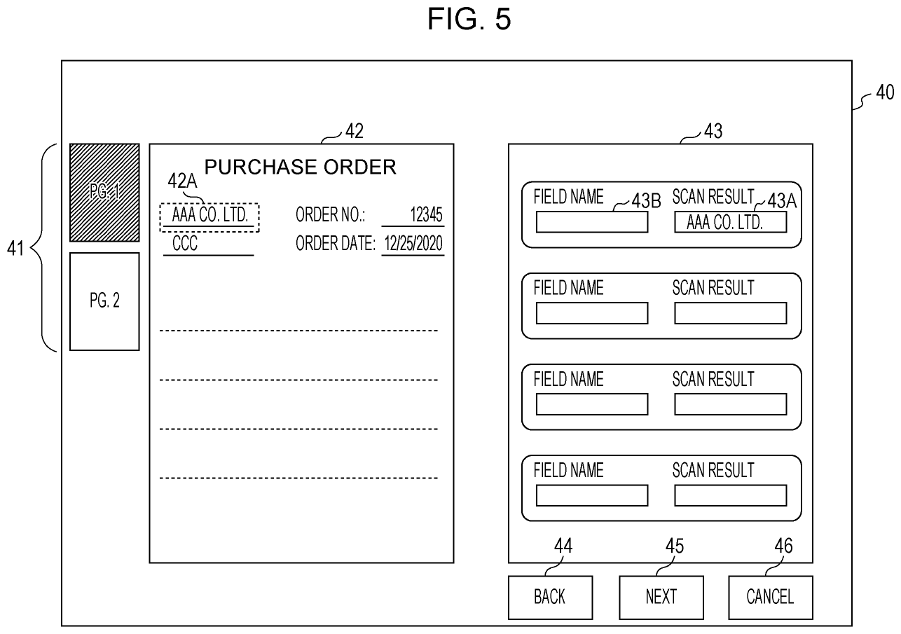

Hereinafter, FIGS. 4 and 5 will be used to describe a method of setting the scanning definition. By setting the scanning definition, the scanning ranges described above, a dictionary referenced to obtain a scan result of characters and symbols inside each scanning range, and data correction for correcting the scan result to predetermined content are set. The set scanning definition is stored in the storage unit 24, for example.

As an example, the dictionary includes a dictionary for recognizing characters corresponding to character sets such as Japanese hiragana, katakana, and kanji, Hepburn romanization, and Arabian numerals, as well as a dictionary for recognizing symbols such as ( ), /, and < >.

Anticipated examples of data correction include correcting a scan result of “Inc.” to “Incorporated”, and correcting a scan result in half-width characters to full-width characters.

Thereafter, characters and symbols inside the scanning ranges are read using one or multiple dictionaries selected by the user, and the scan result is subjected to data correction where appropriate. Note that the data correction may be performed by the information processing device 20 automatically or according to input from the user through the client terminal 40.

FIG. 4 is a first display example displayed on a screen of the client terminal 40. In the display example illustrated in FIG. 4, a thumbnail display area 41, a document display area 42, a result display area 43, a Back button 44, a Next button 45, and a Cancel button 46 are displayed.

In the thumbnail display area 41, thumbnail images of the image data included in a single job are displayed. As an example, in the case where the image data included in the job contains two document pages, two thumbnail images labeled “PG. 1” and “PG. 2” are displayed, as illustrated in FIG. 4. Also, in the thumbnail display area 41, the shaded thumbnail image indicates the image data displayed in the document display area 42. In other words, the shaded thumbnail image in the thumbnail display area 41 may be considered to be selected as the image data to display in the document display area 42.

In the document display area 42, image data of the document corresponding to the thumbnail image selected in the thumbnail display area 41 is displayed. In FIG. 4, the image data of a purchase order that acts as the first form is displayed as the image data of the document to use as a draft for setting the scanning definition. Also, in the document display area 42, characters or symbols displayed above underlines are information that has been written or inputted into the form in advance. As an example, the underlined portions of the form indicate predetermined fields where information is to be written or inputting into the form. Additionally, in FIG. 4, “AAA Co. Ltd.”, “CCC”, “12345”, and “12/25/2020” are information that has been written or inputted into the first form as an example.

In the result display area 43, a scan display area 43A that indicates a scan result of characters and symbols inside a scanning range set as the scanning range for the job and a field display area 43B that indicates a field name corresponding to the scan result are displayed. FIG. 4 is a display example before the scanning ranges are set, and therefore a scan result is not displayed in the scan display area 43A, but after the scanning ranges are set, a scan result is displayed by the information processing device 20 automatically. Also, in the field display area 43B, a field name inputted by the user through the client terminal 40 is displayed after a scan result is displayed in the scan display area 43A, for example.

The Back button 44 is a button for changing the image data displayed in the document display area 42 to the image data of the previous document page. As an example, in the case where the image data of the second document page is being displayed in the document display area 42 and the Back button 44 is operated, the image data of the first document page is displayed in the document display area 42. Note that in the case where the image data of the front-most document page is being displayed in the document display area 42 and the Back button 44 is operated, the image data of the rear-most document page is displayed in the document display area 42.

The Next button 45 is a button for changing the image data displayed in the document display area 42 to the image data of the next document page. As an example, in the case where the image data of the first document page is being displayed in the document display area 42 and the Next button 45 is operated, the image data of the second document page is displayed in the document display area 42. Note that in the case where the image data of the rear-most document page is being displayed in the document display area 42 and the Next button 45 is operated, the image data of the front-most document page is displayed in the document display area 42.

The Cancel button 46 is a button for causing the screen of the client terminal 40 to change to predetermined display content when operated.

FIG. 5 is a second display example displayed on the screen of the client terminal 40. The display example illustrated in FIG. 5 illustrates a state after a scanning range is set in a portion of the information that has been written or inputted into the first form in the image data of the first form displayed in the document display area 42 of FIG. 4.

In FIG. 5, the CPU 21 causes frame information 42A indicating a scanning range to be superimposed onto the image data of the first form displayed in the document display area 42. The frame information 42A is rectangular, and encloses the characters and symbols “AAA Co. Ltd.” in a frame indicated by a dashed line.

As an example, the frame information 42A is created according to a mouse operation by the user. Specifically, after left-clicking to select a predetermined icon not illustrated on the screen of the client terminal 40, the frame information 42A is created by left-clicking a desired position in the document display area 42, dragging the mouse while still holding down the left mouse button, and then releasing the left mouse button. Also, the dimensions and shape of the frame expressed by the created frame information 42A may be changed, and furthermore, the frame may be moved to any position in the document display area 42.

Also, in FIG. 5, the CPU 21 causes a result of scanning the characters and symbols enclosed by the frame information 42A to be displayed in the scan display area 43A of the result display area 43. Specifically, the CPU 21 causes the characters and symbols “AAA Co. Ltd.” to be displayed in the scan display area 43A on the uppermost row of the result display area 43. Note that, although omitted from illustration, before causing the scan result to be displayed in the scan display area 43A, the CPU 21 receives the setting of a dictionary referenced to obtain a scan result of the characters and symbols enclosed by the frame information 42A and the setting of data correction with respect to the scan result. Thereafter, the CPU 21 uses the received dictionary to scan the characters and symbols enclosed by the frame information 42A, performs data correction on the scan result where appropriate, and causes the resulting content to be displayed in the scan display area 43A.

Returning to FIG. 3, in step S11, the CPU 21 causes a scan result of the first form to be displayed. Thereafter, the flow proceeds to step S12.

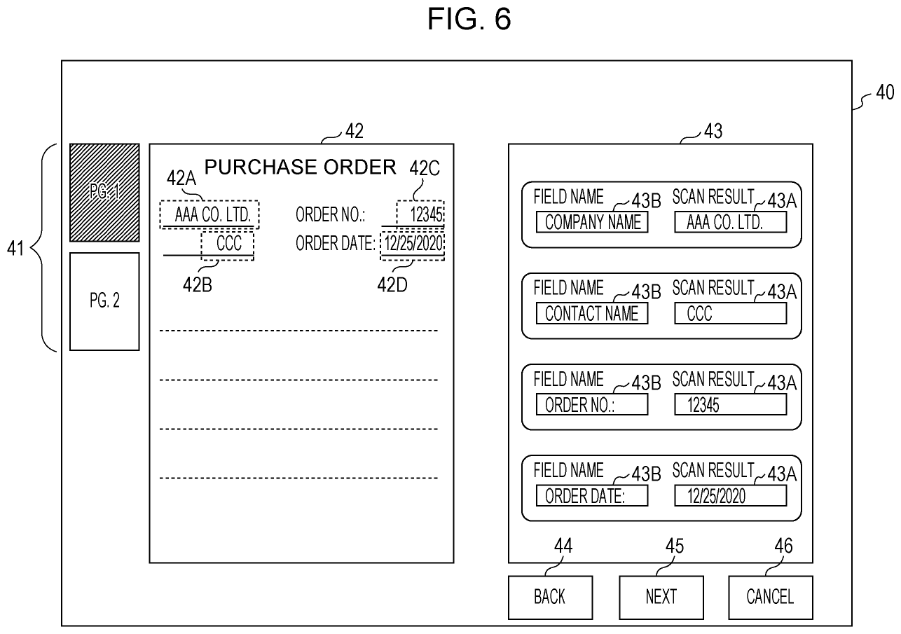

FIG. 6 is a third display example displayed on the screen of the client terminal 40. The display example illustrated in FIG. 6 illustrates a state after additional scanning ranges have been set with respect to the image data of the first form displayed in the document display area 42 of FIG. 5.

In FIG. 6, the CPU 21 causes frame information 42A, 42B, 42C, and 42D indicating scanning ranges to be superimposed onto the image data of the first form displayed in the document display area 42. The frame information 42A, 42B, 42C, and 42D are all rectangular, with the frame information 42B enclosing the characters “CCC”, the frame information 42C enclosing the characters “12345”, and the frame information 42D enclosing the characters and symbols “12/25/2020” in frames indicated by dashed lines.

Also, in FIG. 6, the CPU 21 causes a result of scanning the characters and symbols enclosed by the frame information 42A, 42B, 42C, and 42D to be displayed in the scan display areas 43A of the result display area 43. Specifically, the CPU 21 causes the characters and symbols “AAA Co. Ltd.” to be displayed in the scan display area 43A on the uppermost row of the result display area 43, causes the characters “CCC” to be displayed in the scan display area 43A on the second row from the top, causes the characters “12345” to be displayed in the scan display area 43A on the third row from the top, and causes the characters and symbols “12/25/2020” to be displayed in the scan display area 43A on the lowermost row. Note that, like the frame information 42A described above, before causing the scan result to be displayed in the scan display area 43A, the CPU 21 receives the setting of a dictionary referenced to obtain a scan result of the characters and symbols enclosed by the frame information 42B, 42C, and 42D as well as the setting of data correction with respect to each scan result. Thereafter, the CPU 21 uses the received dictionary to scan the characters and symbols enclosed by the frame information 42B, 42C, and 42D, performs data correction on each scan result where appropriate, and causes the resulting content to be displayed in the scan display area 43A.

Also, in FIG. 6, “Company Name” is displayed in the field display area 43B on the uppermost row of the result display area 43, “Contact Name” is displayed in the field display area 43B on the second row from the top, “Order No.:” is displayed in the field display area 43B on the third row from the top, and “Order Date:” is displayed in the field display area 43B on the lowermost row as field names inputted by the user through the client terminal 40.

Returning to FIG. 3, in step S12, the CPU 21 causes a scan result of a document of similar type to the first form, namely a second form in which information has been written or inputted into predetermined fields, to be displayed. Thereafter, the process ends. The “document of similar type” above refers to a document having a similar type of form in common. As an example of a “document of similar type”, if the first form is a “purchase order”, the second form is also a “purchase order”. Also, in the first exemplary embodiment, forms other than the initial form, that is, the second and subsequent forms from among multiple pages of forms included in a single job, are each treated as the “second form” as an example. The second form is one example of a “second document”.

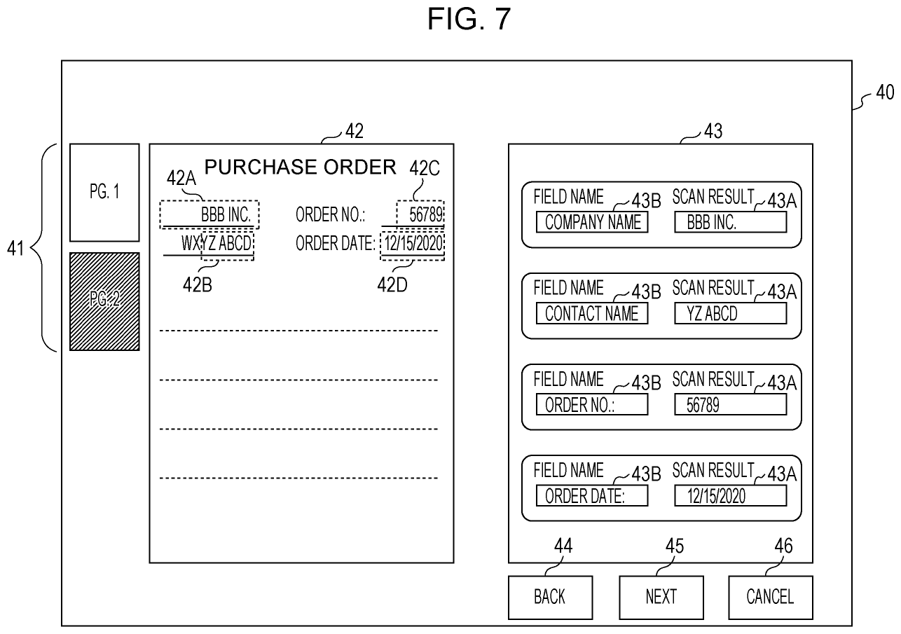

FIG. 7 is a fourth display example displayed on the screen of the client terminal 40. Unlike the display examples from FIGS. 4 to 6 in which the image data of the first form is displayed in the document display area 42, the display example illustrated in FIG. 7 illustrates a state in which image data of the second form is displayed in the document display area 42.

As an example, the CPU 21 causes the display example illustrated in FIG. 7 to be displayed in a case where the Next button 45 is operated while the display example illustrated in FIG. 6 is being displayed. Additionally, in FIG. 7, the result of the CPU 21 scanning the image data of a purchase order acting as the second form by using the scanning definition set in step S10 illustrated in FIG. 3 is displayed. In the first exemplary embodiment, the form layouts of the first form and the second form are similar, as illustrated in FIGS. 6 and 7. In other words, the purchase orders treated as the first form and the second form in which information is written or inputted into predetermined fields (for example, Company Name, Contact Name, Order No., and Order Date) are forms in a standard format. Note that in FIG. 7, “BBB Inc.”, “WXYZ ABCD”, “56789”, and “12/15/2020” are information that has been written or inputted into the second form as an example.

In FIG. 7, the CPU 21 causes frame information 42A, 42B, 42C, and 42D to be superimposed at the same positions and with the same shapes and dimensions as FIG. 6 onto the image data of the second form displayed in the document display area 42. As a result, in FIG. 7, the frame information 42A encloses the characters and symbols “BBB Inc.”, the frame information 42B encloses the characters “YZ ABCD”, the frame information 42C encloses the characters “56789”, and the frame information 42D encloses the characters and symbols “12/15/2020” in frames indicated by dashed lines. In this way, in FIG. 7, among the information written or inputted into the second form, the characters “WX” at the beginning of “WXYZ ABCD” stick out past the frame of the frame information 42B.

In FIG. 7, because the frame information 42A, 42B, 42C, and 42D enclose the characters and symbols as described above, the CPU 21 causes the characters and symbols “BBB Inc.” to be displayed in the scan display area 43A on the uppermost row of the result display area 43, causes the characters “YZ ABCD” to be displayed in the scan display area 43A on the second row from the top, causes the characters “56789” to be displayed in the scan display area 43A on the third row from the top, and causes the characters and symbols “12/15/2020” to be displayed in the scan display area 43A on the lowermost row. Note that in FIG. 7, field names similar to FIG. 6 are displayed in the field display areas 43B of the result display area 43.

Here, a form scanning definition is created on the basis of a single first form in many cases. Also, a scanning definition created on the basis of a first form may be applied to another form of similar type to the first form to scan information that has been written or inputted into the other form in advance. In this case, differences in the information written or inputted into each of the first form and the other form in advance may result in situations where the scanning ranges in the scanning definition are too narrow to read the relevant information, or conversely, the scanning ranges may be too wide and unwanted information may be read. Consequently, it is preferable to check the validity of the application of the scanning definition.

The above issue does not readily occur if the ranges where information is to be written or inputted into the predetermined fields of the form are enclosed with border lines, but the above issue has a high probability of occurring in the case where the ranges where the above information is to be written or inputting are not enclosed with border lines, like in the first exemplary embodiment. The reason is that, in the case where the ranges where the above information is to be written or inputted are enclosed with border lines, it is sufficient simply to create scanning ranges to match the border lines, but in the case where the ranges are not enclosed with border lines, it is difficult to unambiguously define the positions and dimensions of the scanning ranges to create.

Accordingly, in the first exemplary embodiment, the CPU 21 receives the setting of a scanning definition, and causes a result obtained by using the scanning definition to scan a document of similar type to the first form, namely a second form in which information has been written or inputted into predetermined fields, to be displayed.

Consequently, according to the first exemplary embodiment, it is possible to check the validity of whether or not the scanning definition, that is, the definition used when scanning the first form in which information has been written or inputted into predetermined fields, is applicable to the second form of similar type to the first form. For example, a user looking at the display example in FIG. 7 is able to confirm that the current scanning definition is not applicable to the second form, because “WXYZ ABCD” written or inputted into the second form in advance is being displayed as “YZ ABCD” in the scan display area 43A.

Here, in the first exemplary embodiment, it is possible to adjust the set scanning definition. For example, the CPU 21 receives an adjustment to at least one of the position or the dimensions of a scanning range as an adjustment to the scanning definition.

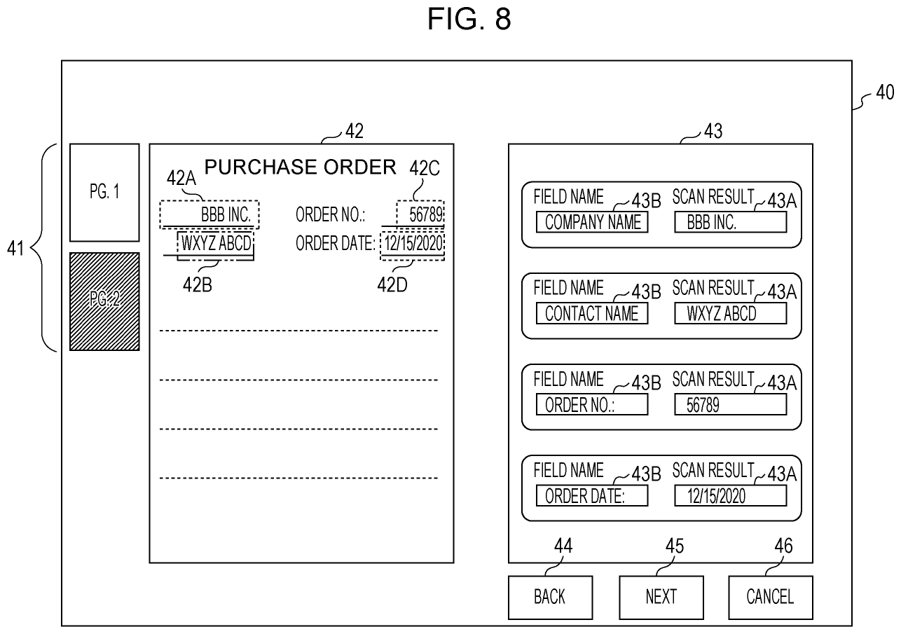

FIG. 8 is a fifth display example displayed on the screen of the client terminal 40. The display example illustrated in FIG. 8 illustrates a state after adjusting the dimensions of the scanning range corresponding to the frame information 42B in the display example illustrated in FIG. 7.

For example, the dimensions of the scanning range are adjusted by a mouse operation performed by the user on the frame information 42B. Specifically, by left-clicking a predetermined position on the frame of the frame information 42B, dragging the mouse while still holding down the left mouse button, and then releasing the left mouse button, the dimensions of the frame of the frame information 42B are enlarged or reduced.

In FIG. 8, the dimensions of the frame of the frame information 42B illustrated in FIG. 7 are enlarged, and the frame information 42B indicating the scanning range encloses the characters “WXYZ ABCD”. Consequently, in FIG. 8, the CPU 21 causes the characters “WXYZ ABCD” to be displayed in the scan display area 43A on the second row from the top of the result display area 43. With this arrangement, a user looking at the display example in FIG. 8 is able to confirm that the adjusted scanning definition is applicable to the second form, because the information written or inputted into the second form in advance is displayed correctly in the scan display areas 43A.

With the above configuration, according to the first exemplary embodiment, the information in each of the forms is scanned using the scanning definition, even in the case where the amount of information written or inputted into each of the first form and the second form is different, such as different numbers of characters and symbols written or inputted in advance, for example.

Here, a configuration also exists in which the form that acts as a draft for setting the scanning definition is not a form included in an actual job to run, but instead is a form for creating the scanning definition. However, with such a configuration, inexpediences are expected to occur during actual operation, and setting an appropriate scanning definition prior to operation may be labor-intensive.

In contrast, with the first exemplary embodiment, a form included in an actual job to run for the first form and the second form is used to set and adjust the scanning definition, and consequently a scanning definition that anticipates the actual job to run may be constructed prior to operation. Also, in the first exemplary embodiment, by appropriately correcting the scanning definition created prior to operation according to the results of processes during operation (for example, the processes of each of (4) confirming or correcting the form identification, (5) confirming or correcting the scan result, and (6) checking the workflow (see FIG. 1)), a scanning definition may be constructed with consideration for the results of the processes during operation.

Here, as described above, in the first exemplary embodiment, the CPU 21 causes frame information indicating a scanning range to be superimposed onto the image data of each of the first form and the second form displayed in the document display area 42. Consequently, according to the first exemplary embodiment, it is possible to confirm the range in which to scan the information in each of the first form and the second form.

Also, in the first exemplary embodiment, in the case of adjusting at least one of the position or the dimensions of a scanning range, the CPU 21 causes the frame information indicating an adjusted scanning range to be displayed with a different appearance than the frame information indicating an unadjusted scanning range. For example, in FIG. 8, the frame information 42B indicating an adjusted scanning range is illustrated with a two-dot chain line, whereas the frame information 42A, 42C, and 42D indicating unadjusted scanning ranges is illustrated with dashed lines. Consequently, according to the first exemplary embodiment, the visibility of frame information indicating an adjusted scanning range is raised compared to a configuration in which the frame information indicating an adjusted scanning range and the frame information indicating an unadjusted scanning range are illustrated with a common appearance.

Furthermore, in the first exemplary embodiment, in the case of using a result of scanning the second form to adjust the scanning definition, the CPU 21 causes a result of scanning the first form using the adjusted scanning definition to be displayed.

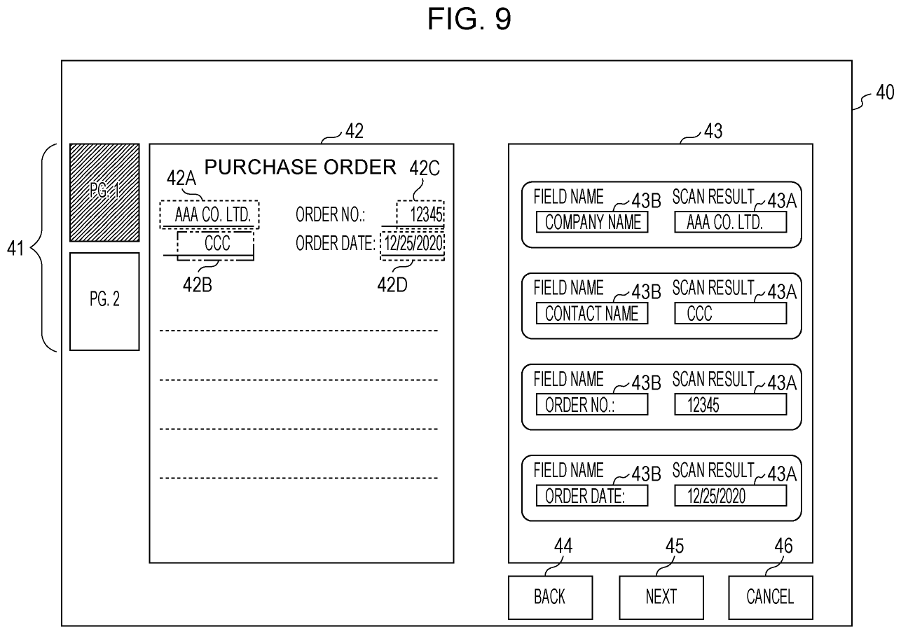

FIG. 9 is a sixth display example displayed on the screen of the client terminal 40. Unlike the display examples in FIGS. 7 and 8 in which the image data of the second form is displayed in the document display area 42, the display example illustrated in FIG. 9 illustrates a state in which image data of the first form is displayed in the document display area 42.

As an example, the CPU 21 causes the display example illustrated in FIG. 9 to be displayed in a case where the Back button 44 is operated while the display example illustrated in FIG. 8 is being displayed. Additionally, in FIG. 9, the result of the CPU 21 scanning the image data of the first form by using an adjusted scanning definition obtained by enlarging the frame of the frame information 42B from the scanning definition set in step S10 illustrated in FIG. 3 is displayed.

In the display example illustrated in FIG. 9, the CPU 21 causes frame information 42A, 42B, 42C, and 42D to be superimposed at the same positions and with the same shapes and dimensions as FIG. 8 onto the image data of the first form displayed in the document display area 42. As a result, in FIG. 9, scan results similar to FIG. 6 are displayed in the scan display areas 43A of the result display area 43.

With the above configuration, according to the first exemplary embodiment, it is possible to check the validity of whether or not the adjusted scanning definition is applicable to the first form of similar type to the second form. For example, a user looking at the display example in FIG. 9 is able to confirm that the adjusted scanning definition is applicable to the first form, because the information written or inputted into the first form in advance is displayed correctly in the scan display areas 43A.

Here, in the first exemplary embodiment, the CPU 21 is capable of receiving a first adjustment including an adjustment to at least one of the position or the dimensions of a scanning range and a second adjustment different from the first adjustment as the adjustment to the scanning definition.

The first adjustment is an adjustment to the scanning definition with respect to the image data of the document displayed in the document display area 42 such that a rescan of the information written or inputted into the document in advance may be necessary. As an example, the first adjustment may include an adjustment to at least one of the position or the dimensions of a scanning range, and furthermore may include an addition or change of the dictionary.

The second adjustment is an adjustment to the scanning definition with respect to the image data of the document displayed in the document display area 42 such that a rescan of the information written or inputted into the document in advance is not necessary. As an example, the second adjustment may include a change to a property such as the line style or color of the frame information indicating a scanning range, without changing the position and dimensions of the scanning range, and may also include data correction.

Additionally, in the first exemplary embodiment, if the received adjustment to the scanning definition is the second adjustment, the CPU 21 does not rescan the information in the first form, whereas if the received adjustment to the scanning definition is the first adjustment, the CPU 21 rescans the information in the first form.

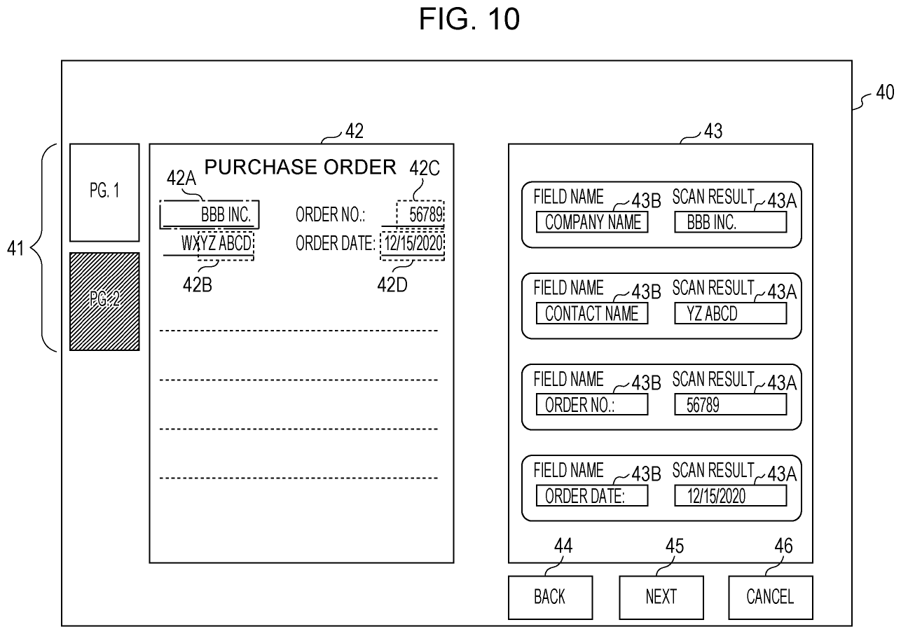

FIG. 10 is a seventh display example displayed on the screen of the client terminal 40. The display example illustrated in FIG. 10 illustrates a state after changing the line style of the frame information 42A in the display example illustrated in FIG. 7. Specifically, the frame information 42A in the display example illustrated in FIG. 10 has a “chain” line style, which has been changed from the “dashed” line style in the display example illustrated in FIG. 7.

As an example, the line style of the frame information 42A is changed according to a mouse operation by the user. Specifically, after left-clicking to select a predetermined icon not illustrated on the screen of the client terminal 40, the line style of the frame information 42A is changed by left-clicking the frame of the frame information 42A.

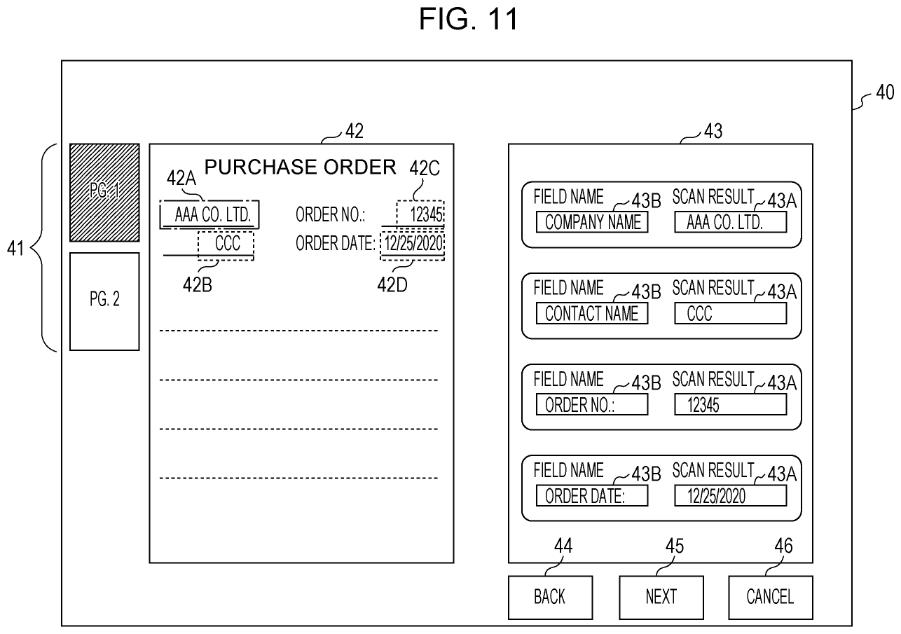

FIG. 11 is an eighth display example displayed on the screen of the client terminal 40. Unlike the display example in FIG. 10 in which the image data of the second form is displayed in the document display area 42, the display example illustrated in FIG. 11 illustrates a state in which image data of the first form is displayed in the document display area 42.

As an example, the CPU 21 causes the display example illustrated in FIG. 11 to be displayed in a case where the Back button 44 is operated while the display example illustrated in FIG. 10 is being displayed. Additionally, in this case, because the received adjustment to the scanning definition is the second adjustment, the CPU 21 does not rescan the information written or inputted into the first form in advance, and instead causes the previous result of scanning the image data of the first form to be displayed in the scan display areas 43A of the result display area 43.

Here, the results of scanning the image data of each of the first form and the second form are stored in the storage unit 24 for example, and in the case where a rescan is not performed as above, the CPU 21 acquires a corresponding scan result from the storage unit 24, and causes the acquired scan result to be displayed in the scan display areas 43A. In other words, the scan display areas 43A in the display example illustrated in FIG. 11 are not displaying the results of a rescan, but rather the information displayed in the scan display areas 43A in the display example illustrated in FIG. 6.

With the above configuration, according to the first exemplary embodiment, a reduction in the speed of the OCR process performed as the scanning process is avoided compared to a configuration that rescans the information in the first form regardless of the content of the received adjustment to the scanning definition.

### Second Exemplary Embodiment

Next, a second exemplary embodiment will be described while omitting or simplifying portions that overlap with other exemplary embodiments.

The second exemplary embodiment describes a case where the dimensions of a scanning range are reduced as an adjustment to the scanning definition.

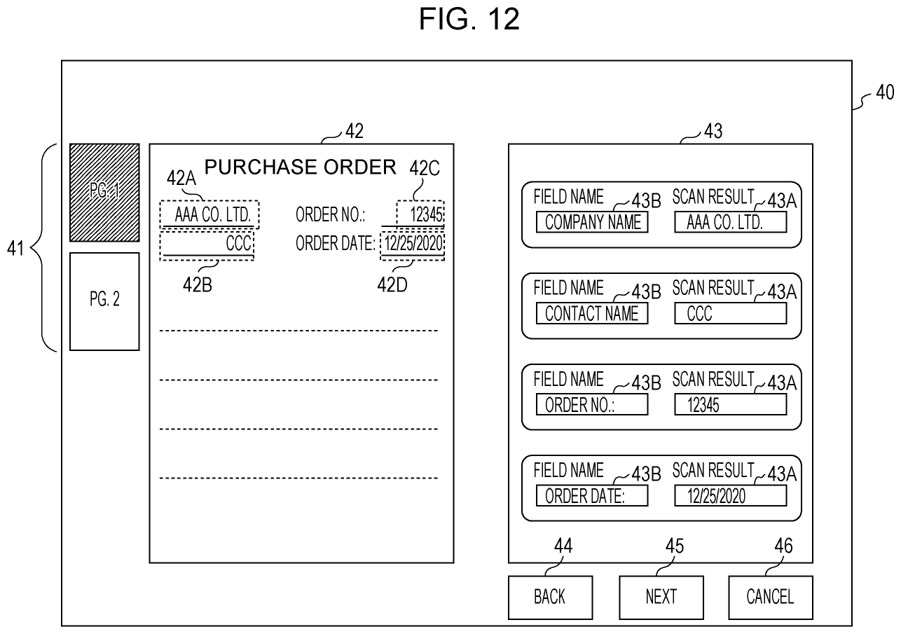

FIG. 12 is a ninth display example displayed on the screen of the client terminal 40. The display example illustrated in FIG. 12 illustrates a state after additional scanning ranges have been set with respect to the image data of the first form displayed in the document display area 42 of FIG. 5.

In FIG. 12, the CPU 21 causes frame information 42A, 42B, 42C, and 42D indicating scanning ranges to be superimposed onto the image data of the first form displayed in the document display area 42. At this time, in FIG. 12, the frame information 42A, 42C, and 42D are displayed at the same positions and with the same shapes and dimensions as FIG. 6, but the dimensions of the frame information 42B have been enlarged compared to the dimensions illustrated in FIG. 6. Specifically, in the frame information 42B illustrated in FIG. 12, the position of the right edge of the frame is the same as the frame information 42B illustrated in FIG. 6, but the left edge of the frame is positioned farther to the left than the frame information 42B illustrated in FIG. 6.

As above, in FIG. 12, the dimensions of the frame information 42B are different from FIG. 6, but scan results similar to FIG. 6 are displayed in the scan display areas 43A of the result display area 43.

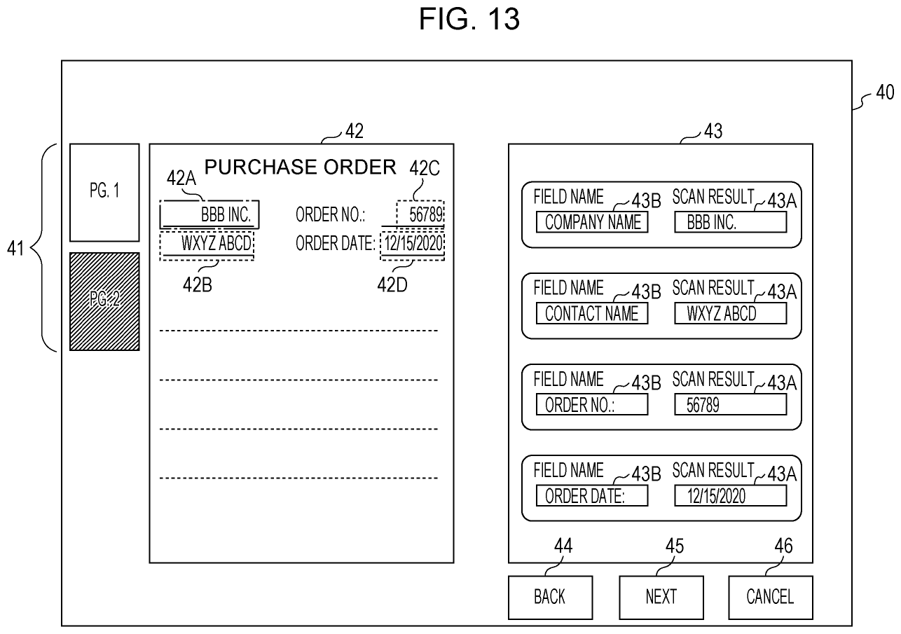

FIG. 13 is a 10th display example displayed on the screen of the client terminal 40. Unlike the display example in FIG. 12 in which the image data of the first form is displayed in the document display area 42, the display example illustrated in FIG. 13 illustrates a state in which image data of the second form is displayed in the document display area 42.

As an example, the CPU 21 causes the display example illustrated in FIG. 13 to be displayed in a case where the Next button 45 is operated while the display example illustrated in FIG. 12 is being displayed. Additionally, in FIG. 13, the CPU 21 causes a result of scanning the characters and symbols enclosed by the frame information 42A, 42B, 42C, and 42D displayed at the same positions and with the same shapes and dimensions as FIG. 12 in the image data of the second form to be displayed. As a result, in FIG. 13, the dimensions of the frame information 42B are different from FIG. 8, but scan results similar to FIG. 8 are displayed in the scan display areas 43A of the result display area 43.

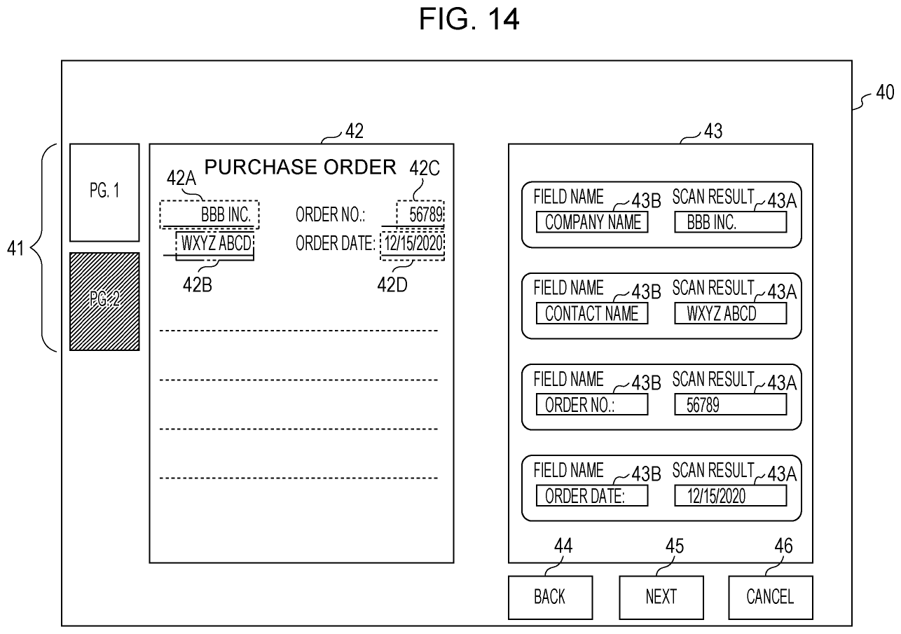

FIG. 14 is an 11th display example displayed on the screen of the client terminal 40. The display example illustrated in FIG. 14 illustrates a state after adjusting the dimensions of the scanning range corresponding to the frame information 42B in the display example illustrated in FIG. 13.

In FIG. 14, the dimensions of the frame information 42B illustrated in FIG. 13 are reduced, and the left edge of the frame is positioned farther to the right than the frame information 42B illustrated in FIG. 13. In this way, in FIG. 14, the dimensions of the frame information 42B illustrated in FIG. 13 are reduced, but the frame encloses the characters “WXYZ ABCD”. Consequently, in FIG. 14, the CPU 21 causes the characters “WXYZ ABCD” to be displayed in the scan display area 43A on the second row from the top of the result display area 43.

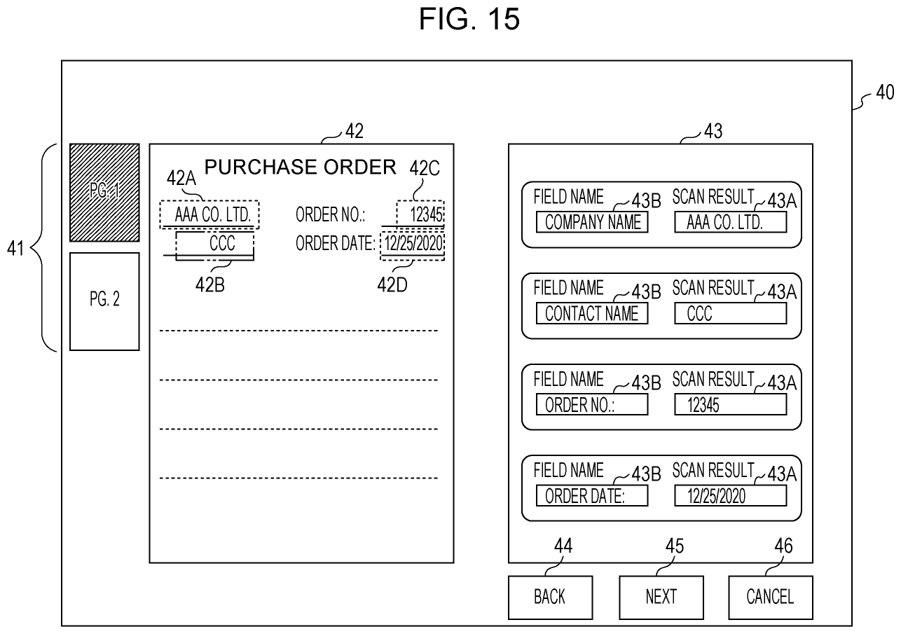

FIG. 15 is a 12th display example displayed on the screen of the client terminal 40. Unlike the display examples in FIGS. 13 and 14 in which the image data of the second form is displayed in the document display area 42, the display example illustrated in FIG. 15 illustrates a state in which image data of the first form is displayed in the document display area 42.

As an example, the CPU 21 causes the display example illustrated in FIG. 15 to be displayed in a case where the Back button 44 is operated while the display example illustrated in FIG. 14 is being displayed. Additionally, in FIG. 15, the CPU 21 causes a result of scanning the characters and symbols enclosed by the frame information 42A, 42B, 42C, and 42D displayed at the same positions and with the same shapes and dimensions as FIG. 14 in the image data of the first form to be displayed. As a result, in FIG. 15, the dimensions of the frame information 42B are different from FIG. 12, but scan results similar to FIG. 12 are displayed in the scan display areas 43A of the result display area 43.

### Third Exemplary Embodiment

Next, a third exemplary embodiment will be described while omitting or simplifying portions that overlap with other exemplary embodiments.

The third exemplary embodiment describes a case where the position of a scanning range is adjusted as an adjustment to the scanning definition.

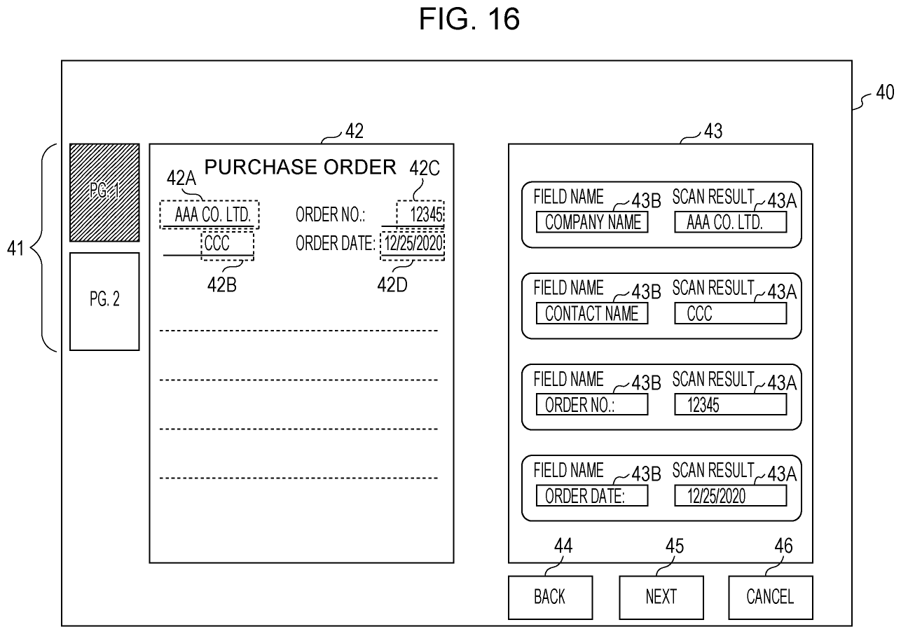

FIG. 16 is a 13th display example displayed on the screen of the client terminal 40. The display example illustrated in FIG. 16 illustrates a state after additional scanning ranges have been set with respect to the image data of the first form displayed in the document display area 42 of FIG. 5.

In FIG. 16, the CPU 21 causes frame information 42A, 42B, 42C, and 42D indicating scanning ranges to be superimposed onto the image data of the first form displayed in the document display area 42. At this time, in FIG. 16, the frame information 42A, 42C, and 42D are displayed at the same positions and with the same shapes and dimensions as FIG. 6, but the dimensions of the frame information 42B have been enlarged compared to the dimensions illustrated in FIG. 6. Specifically, in the frame information 42B illustrated in FIG. 16, the position of the right edge of the frame is the same as the frame information 42B illustrated in FIG. 6, but the left edge of the frame is positioned farther to the left than the frame information 42B illustrated in FIG. 6.

Also, in the first form displayed in the document display area 42 in FIG. 16, “CCC” is included among the information written or inputted in advance like the first form displayed in the document display area 42 in FIG. 6, but the position where “CCC” is written or inputted on the first form is farther to the left than the position illustrated in FIG. 6.

As above, in FIG. 16, the dimensions of the frame information 42B and the position where “CCC” is written or inputted on the first form are different from FIG. 6, but scan results similar to FIG. 6 are displayed in the scan display areas 43A of the result display area 43.

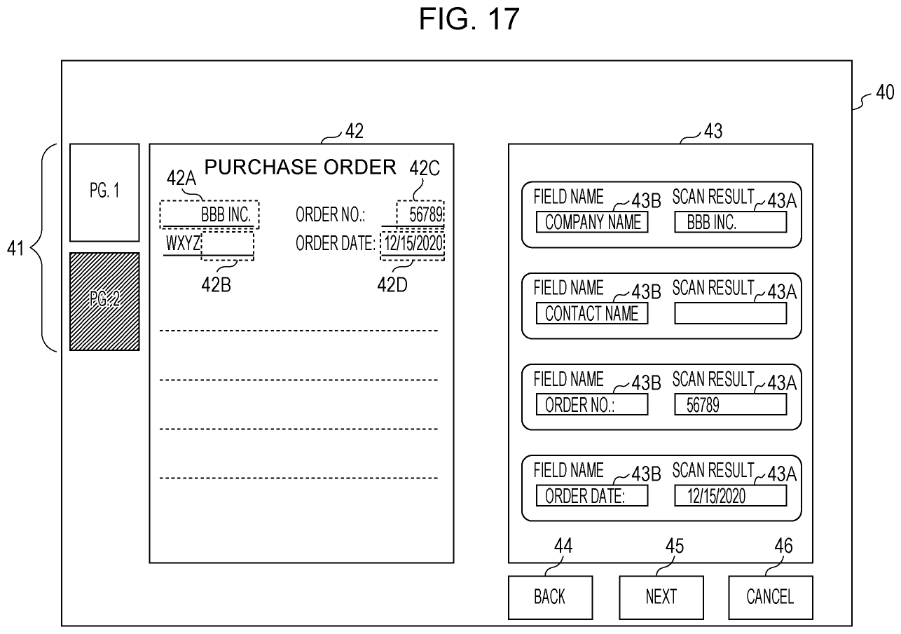

FIG. 17 is a 14th display example displayed on the screen of the client terminal 40. Unlike the display example in FIG. 16 in which the image data of the first form is displayed in the document display area 42, the display example illustrated in FIG. 17 illustrates a state in which image data of the second form is displayed in the document display area 42.

As an example, the CPU 21 causes the display example illustrated in FIG. 17 to be displayed in a case where the Next button 45 is operated while the display example illustrated in FIG. 16 is being displayed. Additionally, in FIG. 17, the CPU 21 causes a result of scanning the characters and symbols enclosed by the frame information 42A, 42B, 42C, and 42D displayed at the same positions and with the same shapes and dimensions as FIG. 16 in the image data of the second form to be displayed. Note that in FIG. 17, “BBB Inc.”, “WXYZ”, “56789”, and “12/15/2020” are information that has been written or inputted into the second form as an example. Additionally, the position of the leading character of “WXYZ” illustrated in FIG. 17 is farther to the left than the position of the leading character of “WXYZ ABCD” illustrated in FIG. 7.

As a result of the above, in FIG. 17, the frame information 42A encloses the characters and symbols “BBB Inc.”, the frame information 42C encloses the characters “56789”, and the frame information 42D encloses the characters and symbols “12/15/2020” in frames indicated by dashed lines, but the frame of the frame information 42B does not enclose any characters or symbols. In other words, in FIG. 17, among the information written or inputted into the second form, the characters “WXYZ” stick out past the frame of the frame information 42B. Consequently, in FIG. 17, the CPU 21 causes scan results similar to FIG. 7 to be displayed in the scan display areas 43A on the uppermost row, the third row from the top, and the lowermost row of the result display area 43, but does not cause any characters or symbols to be displayed in the scan display area 43A on the second row from the top.

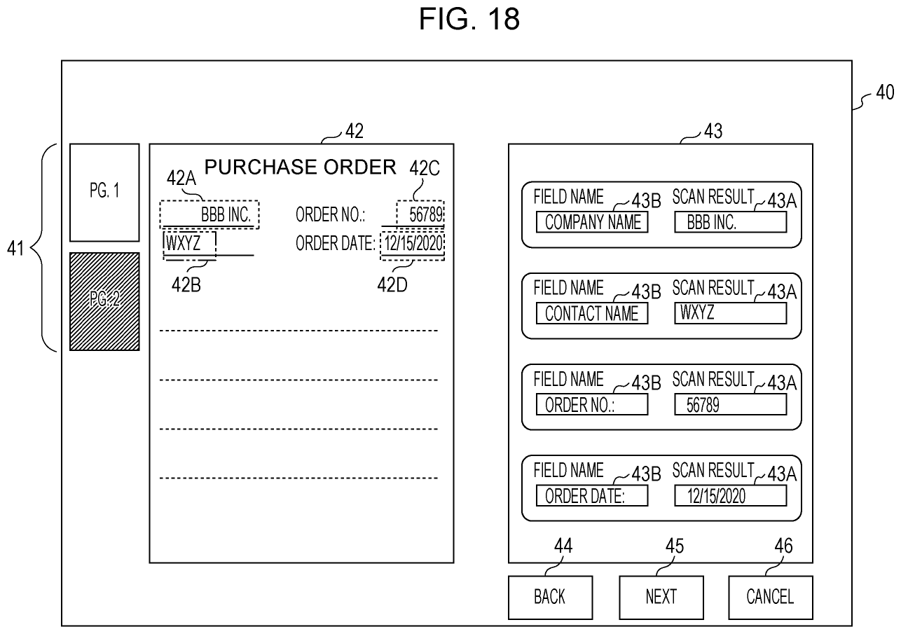

FIG. 18 is a 15th display example displayed on the screen of the client terminal 40. The display example illustrated in FIG. 18 illustrates a state after adjusting the position of the scanning range corresponding to the frame information 42B in the display example illustrated in FIG. 17.

For example, the position of the scanning range is adjusted by a mouse operation performed by the user on the frame information 42B. Specifically, by left-clicking a predetermined position on the frame of the frame information 42B, dragging the mouse while still holding down the left mouse button, and then releasing the left mouse button, the position of the frame of the frame information 42B is moved.

In FIG. 18, the position of the frame is moved without enlarging or reducing the dimensions of the frame of the frame information 42B illustrated in FIG. 17, and the frame information 42B indicating the scanning range encloses the characters “WXYZ”. Consequently, in FIG. 18, the CPU 21 causes the characters “WXYZ” to be displayed in the scan display area 43A on the second row from the top of the result display area 43.

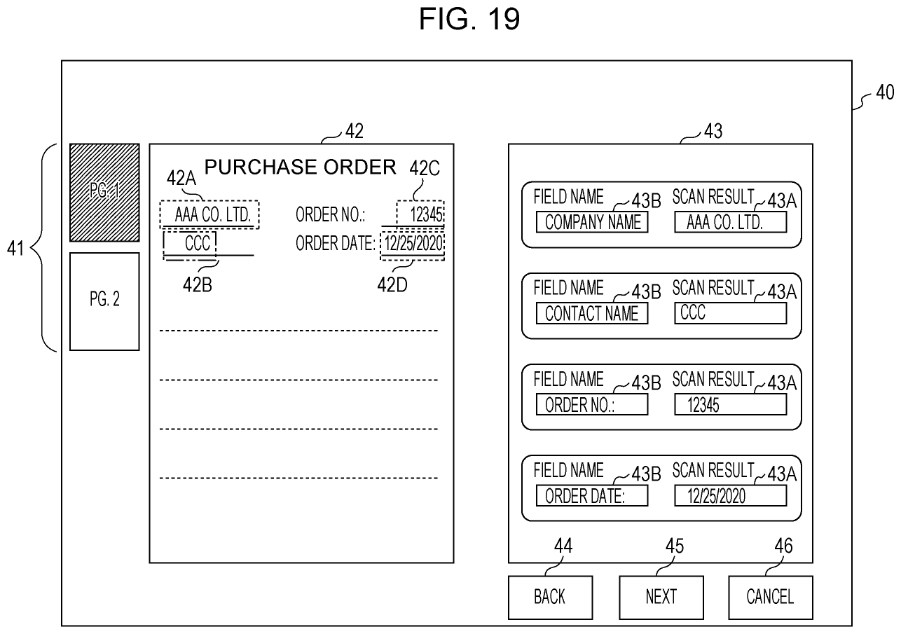

FIG. 19 is a 16th display example displayed on the screen of the client terminal 40. Unlike the display examples in FIGS. 17 and 18 in which the image data of the second form is displayed in the document display area 42, the display example illustrated in FIG. 19 illustrates a state in which image data of the first form is displayed in the document display area 42.

As an example, the CPU 21 causes the display example illustrated in FIG. 19 to be displayed in a case where the Back button 44 is operated while the display example illustrated in FIG. 18 is being displayed. Additionally, in FIG. 19, the CPU 21 causes a result of scanning the characters and symbols enclosed by the frame information 42A, 42B, 42C, and 42D displayed at the same positions and with the same shapes and dimensions as FIG. 18 in the image data of the first form to be displayed. As a result, in FIG. 19, the position of the frame information 42B is different from FIG. 16, but scan results similar to FIG. 16 are displayed in the scan display areas 43A of the result display area 43.

### Fourth Exemplary Embodiment

Next, a fourth exemplary embodiment will be described while omitting or simplifying portions that overlap with other exemplary embodiments.

In the fourth exemplary embodiment, in the case where a search is performed to find a second form from which to scan information using the scanning definition, but the targeted second form is not found, the CPU 21 causes a message indicating that the second form was not found to be displayed.

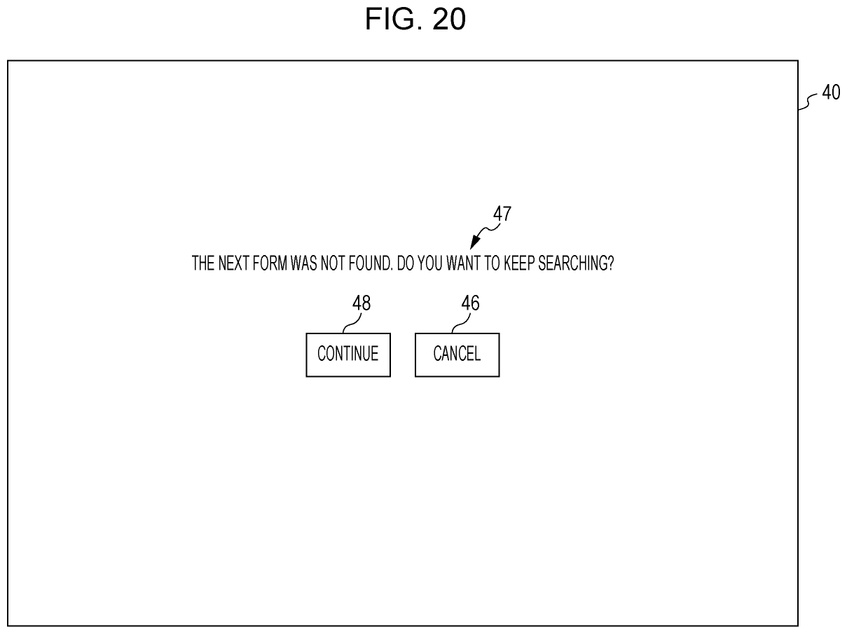

FIG. 20 is a 17th display example displayed on the screen of the client terminal 40. As an example, the CPU 21 causes the display example illustrated in FIG. 20 to be displayed in the case where the Next button 45 is operated a number of times equal to the number of pages (such as PG. 1 and PG. 2, for example) of the forms designated for each job while each of the display examples from FIGS. 6 to 19 are displayed, but the targeted second form is not found. In the display example illustrated in FIG. 20, a message display area 47, a Continue button 48, and the Cancel button 46 are displayed.

The message display area 47 presents a message to the user. For example, in FIG. 20, “The next form was not found. Do you want to keep searching?” is displayed in the message display area 47. With this arrangement, the user looking at the display example in FIG. 2 is able to recognize that the second form was not found.

The Continue button 48 is a button for continuing to search for the second form. For example, in the case where the Continue button 48 is operated while the display example illustrated in FIG. 20 is being displayed, the search for the second form is continued, and the screen of the client terminal 40 changes to predetermined display content. Note that in the case where the Cancel button 46 is operated while the display example illustrated in FIG. 20 is being displayed, the search for the second form is aborted, and the screen of the client terminal 40 changes to predetermined display content.

With the above configuration, according to the fourth exemplary embodiment, the user is made to recognize that the second form has not been found.

Note that in the fourth exemplary embodiment, the CPU 21 may also receive a setting regarding the enabling or disabling of a determination function that determines whether or not a form is the same as the form set as the draft. For example, in the case where the form set as the draft is a “purchase order”, but an “invoice” is mixed in as one of the forms included in the job, enabling the determination function keeps the “invoice” from being divided into records.

Additionally, in the case where the determination function is enabled and attached documents attached to a form are included among the documents included in the job, the CPU 21 may cause the display example illustrated in FIG. 20 to be displayed if the second form is not found after operating the Next button 45 a predetermined number of times (for example, five times) in addition to the number of pages of the forms designated for each job while each of the display examples from FIGS. 6 to 19 are displayed. By taking such a configuration, the user is made to confirm whether or not to continue the search for the second form with consideration for attached documents, which often contain a variable number of pages.

(Other)

In the foregoing exemplary embodiments, the leading form among multiple pages of forms included in a single job is treated as the “first form”, but in the case where a trailing form, that is, a subsequent form after the leading form, is selected as the draft for setting the scanning definition, the trailing form is treated as the “first form”. Also, in the foregoing exemplary embodiments, the trailing form(s) subsequent to the leading form among the multiple pages of forms included in a single job is treated as the “second form”, but in the case where a trailing form is treated as the “first firm”, the forms other than the first form, including the leading form, are treated as the “second form”.

In the foregoing exemplary embodiments, the frame information indicating a scanning range is created by a mouse operation performed by the user, but the configuration is not limited thereto, and the frame information may also be created by the information processing device 20 automatically. As an example, in the case where a layout definition specifying which portions of the form layout of a form are to be scanned from a specific form (for example, a purchase order) is defined, the layout definition may be used to create the frame information automatically.

In the foregoing exemplary embodiments, the dimensions of a scanning range are adjusted by a mouse operation performed by the user on the frame information indicating the scanning range, but the configuration is not limited thereto, and the dimensions of the scanning range may also be adjusted by the information processing device 20 automatically. As an example, the information processing device 20 may recognize the dimensions of characters, symbols, or the like sticking out from the frame of the frame information, and enlarge the dimensions of the frame of the scanning range such that the portion sticking out is contained inside the frame. Note that in the case where the dimensions of a scanning range are adjusted automatically, the information processing device 20 may adjust the dimensions with consideration for the dimensions of characters, symbols, and the like only on pages where the characters, symbols, and the like are not read correctly, or with consideration for the dimensions of characters, symbols, and the like on the pages of other forms included in the job.

The foregoing exemplary embodiments describe a case where the first form and the second form have a similar form layout as an example, but the foregoing exemplary embodiments are also applicable to cases where the first form and the second form have different form layouts. In other words, the forms treated as the first form and the second form in which information is written or inputted into predetermined fields (for example, Company Name, Contact Name, Order No., and Order Date) may also be in a non-standard format.

In the foregoing exemplary embodiments, the CPU 21 causes the frame information indicating an adjusted scanning range and the frame information indicating an unadjusted scanning range to be displayed with different line styles as a way of displaying each type of frame information with a different appearance, but the “different appearance” is not limited thereto. Examples of the “different appearance” described above may also include differentiating the shape or each line and differentiating the color of each line.

The foregoing exemplary embodiments describe an example in which either one of the position or the dimensions of a scanning range are adjusted as the adjustment to the scanning definition, but the configuration is not limited thereto, and both the position and the dimensions of a scanning range may be adjusted.

In the foregoing exemplary embodiments, job rules are created by the process of “(1) workflow design and operation verification”, but a job rule set combining multiple job rules may be created additionally in the process of “(1) workflow design and operation verification”.

Note that each of the foregoing exemplary embodiments and the content described in the (Other) section may be combined appropriately.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to:
receive a setting of a scanning definition, the scanning definition being a definition to be used when scanning information in a first document in which information has been written or inputted into predetermined fields; and
cause a result obtained by using the scanning definition to scan a document of similar type to the first document, namely a second document in which information has been written or inputted into predetermined fields, to be displayed.

2. The information processing device according to claim 1, wherein
the processor is configured to:
receive an adjustment to at least one of a position or a dimension of a scanning range in which to read information from each of the first document and the second document as an adjustment to the scanning definition.

3. The information processing device according to claim 2, wherein
in a case of adjusting the scanning definition using the result of scanning the second document, the processor is configured to cause a result obtained by using the adjusted scanning definition to scan the first document to be displayed.

4. The information processing device according to claim 3, wherein
the processor is configured to receive a first adjustment including an adjustment to at least one of a position or a dimension of the scanning range and a second adjustment different from the first adjustment as the adjustment to the scanning definition, and
in a case where the received adjustment to the scanning definition is the second adjustment, the processor is configured not to rescan the information in the first document, and in a case where the received adjustment to the scanning definition is the first adjustment, the processor is configured to rescan the information in the first document.

5. The information processing device according to claim 2, wherein
the processor is configured to cause frame information indicating the scanning range to be superimposed onto each of the displayed first document and second document.

6. The information processing device according to claim 3, wherein
the processor is configured to cause frame information indicating the scanning range to be superimposed onto each of the displayed first document and second document.

7. The information processing device according to claim 4, wherein
the processor is configured to cause frame information indicating the scanning range to be superimposed onto each of the displayed first document and second document.

8. The information processing device according to claim 5, wherein
in a case of adjusting at least one of a position or a dimension of the scanning range, the processor is configured to cause frame information indicating an adjusted scanning range to be displayed with a different appearance than frame information indicating an unadjusted scanning range.

9. The information processing device according to claim 6, wherein
in a case of adjusting at least one of a position or a dimension of the scanning range, the processor is configured to cause frame information indicating an adjusted scanning range to be displayed with a different appearance than frame information indicating an unadjusted scanning range.

10. The information processing device according to claim 7, wherein
in a case of adjusting at least one of a position or a dimension of the scanning range, the processor is configured to cause frame information indicating an adjusted scanning range to be displayed with a different appearance than frame information indicating an unadjusted scanning range.

11. The information processing device according to claim 1, wherein
in a case where a search is performed to find the second document from which to scan information using the scanning definition, but the targeted second document is not found, the processor is configured to cause a message indicating that the second document was not found to be displayed.

12. The information processing device according to claim 2, wherein
in a case where a search is performed to find the second document from which to scan information using the scanning definition, but the targeted second document is not found, the processor is configured to cause a message indicating that the second document was not found to be displayed.

13. The information processing device according to claim 3, wherein
in a case where a search is performed to find the second document from which to scan information using the scanning definition, but the targeted second document is not found, the processor is configured to cause a message indicating that the second document was not found to be displayed.

14. The information processing device according to claim 4, wherein
in a case where a search is performed to find the second document from which to scan information using the scanning definition, but the targeted second document is not found, the processor is configured to cause a message indicating that the second document was not found to be displayed.

15. The information processing device according to claim 5, wherein
in a case where a search is performed to find the second document from which to scan information using the scanning definition, but the targeted second document is not found, the processor is configured to cause a message indicating that the second document was not found to be displayed.

16. The information processing device according to claim 6, wherein
in a case where a search is performed to find the second document from which to scan information using the scanning definition, but the targeted second document is not found, the processor is configured to cause a message indicating that the second document was not found to be displayed.

17. The information processing device according to claim 7, wherein
in a case where a search is performed to find the second document from which to scan information using the scanning definition, but the targeted second document is not found, the processor is configured to cause a message indicating that the second document was not found to be displayed.

18. The information processing device according to claim 8, wherein
in a case where a search is performed to find the second document from which to scan information using the scanning definition, but the targeted second document is not found, the processor is configured to cause a message indicating that the second document was not found to be displayed.

19. The information processing device according to claim 9, wherein
in a case where a search is performed to find the second document from which to scan information using the scanning definition, but the targeted second document is not found, the processor is configured to cause a message indicating that the second document was not found to be displayed.

20. A non-transitory computer readable medium storing a program causing a computer to execute a process for processing information, the process comprising:
receiving a setting of a scanning definition, the scanning definition being a definition to be used when scanning information in a first document in which information has been written or inputted into predetermined fields; and
causing a result obtained by using the scanning definition to scan a document of similar type to the first document, namely a second document in which information has been written or inputted into predetermined fields, to be displayed.
